(19) United States
(12) Patent Application Publication
(10) Pub. No.: US 2005/0158696 A1
(43) Pub. Date: Jul. 21, 2005

(54) [INTERACTIVE COMPUTER-ASSISTED LANGUAGE LEARNING METHOD AND SYSTEM THEREOF]

(76) Inventor: Jia-Lin Shen, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,124

(22) Filed: Apr. 15, 2004

(30) Foreign Application Priority Data
Jan. 20, 2004 (TW) 93101483

(51) Int. Cl. G09B 19/00; G09B 5/04

(52) U.S. Cl. 434/219; 434/169

(57) ABSTRACT

An interactive computer-assisted language learning method implemented by means of a language learning system is provided. First, the correct pronunciation of a first sentence is output from the language learning system. Thereafter, a learner pronounces the first sentence in imitation to the correct pronunciation. The first pronunciation by the learner is compared with the correct pronunciation according to the language learning system. The learner may pronounce the sentence again according to the compared result. A comment according to these results of the comparison is output to show the learner's faults. Meanwhile, the language learning system also pronounces a second sentence with a pronunciation similar to the first sentence and phrases, examples, synonyms related to the first sentence so that the learner can learn grammar and practice hearing skills simultaneously. The language learning system points out the blind spots of learning to learner immediately and interacts with the learner timely to improve learning efficiency.

### CROSS REFERENCE TO RELATED APPLICATIONS This application claims the priority benefit of Taiwan application serial no. 93101483, filed Jan. 20, 2004.

### BACKGROUND OF INVENTION

1. Field of the Invention

The present invention relates to a language learning system and method. More particularly, the present invention relates to interactive computer-assisted language learning method and system.

2. Description of the Related Art

Language is a major tool for communication between people. In this global village century, the capacity to communicate in a multiple languages is a great personal asset.

At present, languages can be learnt through self-study aids including books, television, learning cassettes, compact discs, broadcast and the internet or interactive communication with a language teacher. In recent years, the popularization of computers renders computer-assisted language learning method possible. One big advantage of learning through the software inside a computer-assisted language learning system is that language learning is no longer restricted to a particular period of time or limited to a particular location. Furthermore, language learning software has advanced from a unidirectional output mode to a bidirectional output mode. Voice recognition techniques are frequently deployed to analyze the learner”s pronunciation and provide a reference feedback to the learner. Moreover, a voice synthesizer or a pre-recorded sound track can be used to provide a model pronunciation to the learners so that the learners may correct their own pronunciation according to the model.

In general, a language learner needs to master three major aspects of a language, namely, vocalizing, hearing and grammar. At present, most computer-assisted language learning software has attained basic bidirectional communication in vocalization. However, hearing and grammar still remains in a unidirectional learning mode. Moreover, most pronunciation software packages are only able to analyze the pronunciation of each word pronounced by the learner and provide a comparison with the correct pronunciation by means of a marking scheme. Although the learners can improve their pronunciation to a level similar to the correct pronunciation after repeated training, the method only provides the learner with segmental learning. In other words, what the learner can learn is the correct pronunciation of single words so that the learner may not distinguish between words having a similar pronunciation.

Furthermore, a conventional language learning system has no facility for gathering information about the shortcomings of a learner and providing related information for improvement in return. Consequently, an erroneous pronunciation of words may be unknowingly reproduced in another exercise after the learner has pronounced a similar word in a previous exercise. Ultimately, the learning efficiency is hard to improve.

In addition, the conventional language learning system stores its learning program inside an accessible computer terminal or inside a remote computer terminal and accessed through the internet. In general, the learner has to look up the required program from a content list. Therefore, it is inconvenient for the learner to get the language training for a particular type of situation such as ordering from a menu or booking a hotel room in advance. This is a great inconvenience to the learner who has access to the language learning system.

### SUMMARY OF INVENTION

Accordingly, at least one objective of the present invention is to provide an interactive computer-assisted language learning method that can increase the interactivity with learners and strengthen the learners” weak points by providing exercises targeting errors they frequently made.

At least a second objective of the present invention is to provide a language learning system that can supply a particular learning program on request and provide exercises that integrate hearing, grammar and vocalization together so that the learner is able to get complete bidirectional language training.

To achieve these and other advantages and in accordance with the purpose of the invention, as embodied and broadly described herein, the invention provides an interactive computer-assisted language learning method that can be implemented through a language learning system. First, a first sentence is pronounced according to a first acoustic signal stored inside the language learning system. The learner pronounces the first sentence to produce a first pronunciation signal by imitating the pronunciation provided by the language learning system. Thereafter, the language learning system compares the first acoustic signal with the first pronunciation signal to produce a first compared result. The learner modifies the first pronunciation according to the first compared result and produces a second pronunciation so that a second acoustic signal is registered by the language learning system. The language learning system compares the first acoustic signal with the second acoustic signal to produce a second compared result. Through the registered first and second compared result, the language learning system performs an analysis and outputs a comment to the learner for reference.

According to one embodiment of the present invention, the learner may first select the learning program. Thereafter, the language learning system picks up the first sentence from the requested learning program. The learner can select the required learning program by inputting a voice command or a textual command.

According to one embodiment of the present invention, the language learning system may output a multiple of pronunciations of the second sentence. Furthermore, each pronunciation of the second sentence belongs to a group of pronunciations that easily confuse with the pronunciation of the first sentence so that the learner is trained to distinguish between the pronunciation of the first sentence and the second sentence. In addition, the language learning system may output full sentences, phrases and synonyms that are closely related to the first sentence so that the learner is able to learn grammar and hearing as well.

According to one embodiment of the present invention, the comment is either announced vocally or displayed as a textual message.

According to one embodiment of the present invention, the language learning system has the capacity to design a special program for training the pronunciation of the learner according to the compared result so that the weak points of the learner can be strengthened.

The present invention also provides a language learning system. The language learning system mainly comprises a voice recognition engine, a database, an analysis/processing unit and a voice-synthesizing unit. The voice recognition engine recognizes a multiple of pronunciations of a first sentence produced by the learner and outputs a first pronunciation signal corresponding from the database to each first sentence. The database stores a plurality of acoustic signals that includes a multiple of first acoustic signals. Furthermore, each first acoustic signal corresponds to the pronunciation of one of the first sentences.

The analysis/processing unit is connected to the voice recognition engine and the database for comparing the first pronunciation signal from the voice recognition engine with the fist acoustic signal from the database to produce and register a compared result. According to the compared result, the analysis/processing unit outputs a comment to the learner for reference. Thereafter, the compared result is used to design a special program for training the pronunciation of the learner. The voice-synthesizing unit is connected to the analysis/processing unit for converting the textual data from the database into vocal sound.

According to one embodiment of the present invention, the language learning system further comprises a learning interface. The learning interface is connected to the voice recognition engine and the voice-synthesizing unit for receiving a command from the learner and transferring the command to the analysis/processing unit. The analysis/processing unit selects a learning program from the database according to the command and displays the learning program on the learning interface. The first sentence is selected from the chosen learning program. The command feeds in by the learner can be a voice command or a textual command. After performing an analysis on the voice command, the voice recognition engine converts the voice command into a textual command.

According to one embodiment of the present invention, the database holds full sentences, phrases, synonyms or a combination of them that are closely related to each first sentence. In another embodiment of the present invention, the database preferably holds a plurality of second acoustic signals as well. Each second acoustic signal corresponds to the pronunciation of a second sentence. Furthermore, the pronunciation of each second sentence is very similar to the pronunciation of each first sentence.

Since the present invention has the capacity to record the learning history, perform analysis of the learning process and provide timely statements on the blind spot of a language learner, the learner is prevented from repeating the same mistake again. In other words, the learning efficiency of the learner can be improved. Furthermore, the invention also provides a learner learning the pronunciation of a single word with other easily confused words so that the learner is trained to distinguish their differences. In addition, the present invention also provides full sentences, phrases and synonyms that are closely related to the single words so that learners may simultaneously improve their grammatical understanding and hearing while pronouncing the words. Hence, the present invention is able to provide the learner with continuous learning instead of piecewise learning.

In addition, the present invention permits the learners to select their required learning programs. The learner may select the learning program through a voice command or by textual input so that the language learning system can be used in a flexible way.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing a language learning system according to one preferred embodiment of the present invention.

FIG. 2 is a flowchart showing the steps carried out in an interactive computer-assisted language learning process according to the present invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

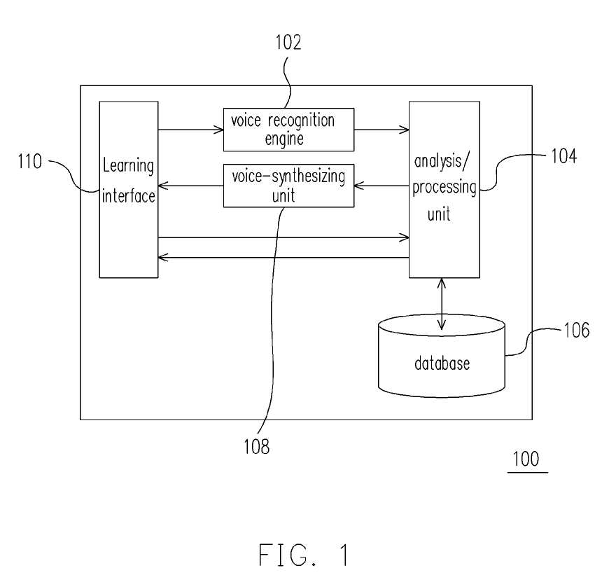

FIG. 1 is a block diagram showing a language learning system according to one preferred embodiment of the present invention. As shown in FIG. 1, the language learning system 100 mainly comprises a voice recognition engine 102, a database 106, an analysis/processing unit 104 and a voice-synthesizing unit 108. The voice recognition engine 102 is connected to the analysis/processing unit 104 for receiving a learner's pronunciation of a first sentence and outputting a corresponding first pronunciation signal after performing an recognition of the learner's pronunciation. The first sentence can be a single word, a phrase or a full sentence, for example. The database 106 is a storage area for holding learning programs and a plurality of acoustic signals. The acoustic signals further comprise all the first acoustic signals that correspond to the pronunciation of the first sentence.

The analysis/processing unit 108 is connected to the voice recognition engine 102 and the database 106. When the learner practices the pronunciation of the first sentence, the voice recognition engine 102 will receive and recognize the pronunciation produced by the learner. Thereafter, the recognized first voice signal is output to the analysis/processing unit 104. The analysis/processing unit 104 reads out the first acoustic signal from the database 106 and compares with the first voice signal so that a compared result is output to the learner for reference. In the meantime, the analysis/processing unit 104 will also record the learning history of the learner. After performing an analysis and summary on the learning history of the learner, a learning program for training the learner in proper pronunciation with special attention to the most common mistakes is designed. Thus, the leaner can have more practice to strengthen their weak points.

Furthermore, after performing an analysis on the first sentence, the analysis/processing unit 104 may read out a second acoustic signal from the database 106 that has a pronunciation so similar to the first sentence that it can be easily confused with the first sentence. Thereafter, the second acoustic signal is output via the voice-synthesizing unit 108 so that the learner is reminded about some confusing single words and learns to distinguish between them. For example, when a learner is practicing the pronunciation of the word “bat”, the analysis/processing unit 104 may read out words that have a similar pronunciation such as “bet” and “bait” so that the learner can learn about these new words and avoid messing up the words later on. The analysis/processing unit 104 gathers all second sentences whose correct pronunciation is similar to the first sentence together and defines them as a group of easily confused words.

When a learner uses the language learning system 100 of the present invention to practice the pronunciation of single words, the analysis/processing unit 104 will also read out phrases, full sentences or synonyms closely related to the respective single words from the database 106. Through the voice-synthesizing unit 108, these phrases, full sentences or synonyms are pronounced so that the learner is able to learn some related grammatical knowledge other than word pronunciation and hence increase learning continuity.

The voice-synthesizing unit 108 is connected to the analysis/processing unit 104 for converting textual output from the language learning system 100 into voiced sound so that the learner is able to hear and follow.

The language learning system 100 according to the present invention may further comprise a learning interface 110 so that a learner may select a desired learning program. As shown in FIG. 1, the learning interface 100 is connected to the voice recognition engine 102 and the voice-synthesizing unit 108 for receiving learner's input command and re-directing the command to the analysis/processing unit 104. According to the command, the analysis/processing unit 104 retrieves acoustic signal from the database 106 and then transmits the acoustic signal to the learning interface 110 to produce the required training program.

Aside from using a keyboard to input textual command, the learner may also choose to use voice commands to select the required training program. When the learner uses a voice command to select the learning course, the voice recognition engine 102 can be used to recognize the voice command from the learning interface 110 and convert the voice command into textual command before transmitting to the analysis/processing unit 104.

Since the language learning system of the present invention permits a bidirectional interaction with the learner, language learning efficiency is improved.

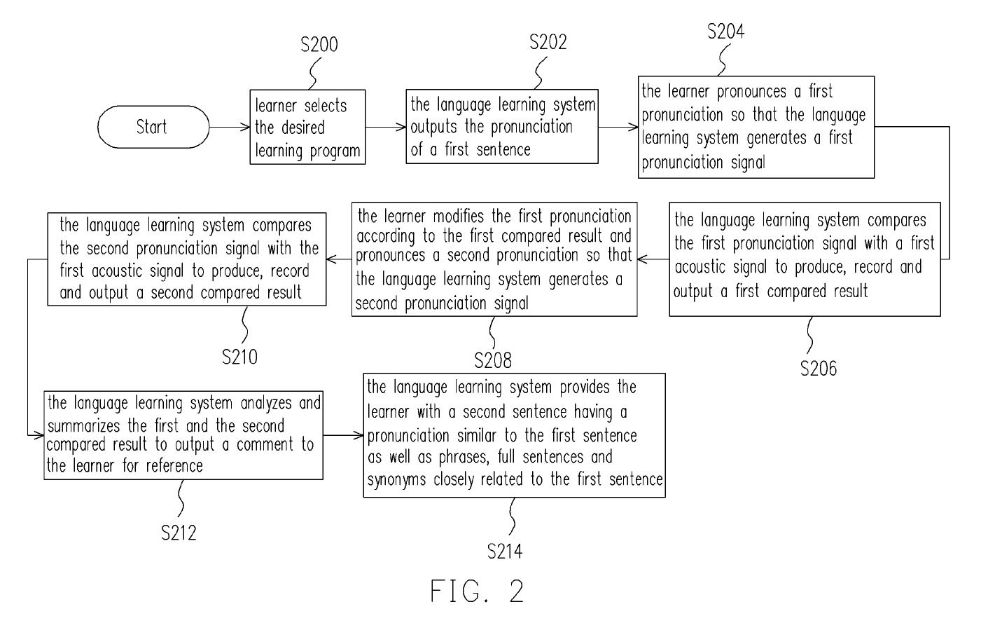

FIG. 2 is a flowchart showing the steps carried out in an interactive computer-assisted language learning process according to the present invention. The learning process can be executed using the language learning system 100 (as shown in FIG. 1). In step S200, the learner selects the desired learning program. The learner may rely on a voice command to select or search for a particular learning program. Alternatively, the learner may use a keyboard to input textual commands to select or search for the learning program.

In step S202, the language learning system outputs the pronunciation of a first sentence. The first sentence can be a single word, a phrase or a full sentence, for example. In this embodiment, a single word is pronounced. In step S204, the learner imitates the pronunciation of the language learning system to produce a first pronunciation thereby generating a first pronunciation signal inside the language learning system. In step S206, the language learning system compares the first acoustic signal with the first pronunciation signal to produce a first compared result.

In step S208, the learner may modify the first pronunciation according to the first compared result presented in step S206 and produce a second pronunciation. The second pronunciation generates a second pronunciation signal inside the language learning system. Thereafter, in step S210, the language learning system compares the first acoustic signal with the second pronunciation signal to produce a second compared result.

In step S212, the language learning system analyzes and summarizes the first and the second compared result recorded in steps S206 and S210 to discover the learner”s blind spot in learning and output a comment to the learner for reference. The comment is displayed in textual format or reported in voice format, for example.

In step 214, the present invention further provides the learner with a second sentence that has a pronunciation very similar to the first sentence. Hence, the learner can avoid confusing single words with a similar pronunciation. In addition, the present invention also provides phrases, full sentences and synonyms related to the first sentence so that the learner can learn some grammar and clauses aside from the pronunciation. Ultimately, the learning program can provide the learner with a greater continuity.

Since the present invention is capable of recording the learning history of a learner, perform analysis of the learning process and provide timely statements on the blind spot of the learner, the learner is prevented from repeating the same mistake again. In other words, the learning efficiency of the learner can be improved.

Furthermore, the invention also provides a learner learning the pronunciation of single words with other easily confused words so that the learner is trained to distinguish their differences. In addition, the present invention also provides full sentences, phrases and synonyms that are closely related to the single words so that learners may simultaneously improve their grammatical understanding and hearing while practicing pronunciation. Consequently, the present invention is able to provide the learner with continuous learning instead of piecewise learning.

In addition, the present invention permits the learners to select their own learning programs. The learner may select the learning program through a voice command or a textual command so that the language learning system can be used in a flexible way.

In conclusion, the present invention provides an interactive computer-assisted language learning method with a higher degree of interaction between the language learning system and the learner to improve learning efficiency.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An interactive computer-assisted language learning method implemented using a language learning system, the method comprising:
the language learning system pronouncing a first sentence according to a first acoustic signal stored inside the language learning system;
a learner producing a first pronunciation by imitating the pronunciation produced by the language learning system so that a first pronunciation signal is recorded by the language learning system;
the language learning system comparing the first acoustic signal with the first pronunciation signal to record and output a first compared result;
the learner producing a second pronunciation according to the first compared result so that the a second pronunciation signal is recorded by the language learning system;
the language learning system comparing the first acoustic signal with the second pronunciation signal to record and output a second compared result; and
the language learning system analyzing and summarizing the first and the second compared result to provide a comment to the learner as a reference.

2. The method of claim 1, wherein the method further comprises permitting the learner to select a desired learning program so that the first sentence is the first sentence of the selected learning program.

3. The method of claim 2, wherein the step of selecting the desired learning program comprises inputting a voice command.

4. The method of claim 2, wherein the step of selecting the desired learning program comprises inputting a textual command.

5. The method of claim 1, wherein the method further comprises the step of:
the language learning system outputting the pronunciation of a plurality of second sentences according to second acoustic signals stored inside the language learning system, wherein all the second sentences belong to a group having a pronunciation that can easily confuse with the pronunciation of the first sentence.

6. The method of claim 1, wherein the method further comprises the step of:
the language learning system outputting full sentences, synonyms and phrases related to the pronunciation of the first sentence.

7. The method of claim 1, wherein the comment is presented to the learner by displaying text on a screen or vocalizing the commenting words.

8. The method of claim 1, wherein the method further comprises the language learning system designing a vocal training program according to the recorded first and second compared result.

9. A language learning system, comprising:
a voice recognition engine for recognizing the pronunciation of a plurality of first sentences produced by a learner and outputting a first pronunciation signal corresponding to each pronunciation of the first sentence;
a database for holding a plurality of first acoustic signals with each first acoustic signal corresponding to a pronunciation of the first sentence;
an analysis/processing unit connected to the voice recognition engine and the database for comparing the first pronunciation signals output from the voice recognition engine and the first acoustic signals retrieved from the database to produce and output a compared result, outputting a comment to the learner according to the compared result, and designing a special program for training the pronunciation of the learner; and
a voice-synthesizing unit connected to the analysis/processing unit for converting the first sentence output from the database into a vocal sound.

10. The language learning system of claim 9, wherein the system further comprises a learning interface connected to the voice recognition engine and the voice-synthesizing unit for receiving a command from the learner and sending the command to the analysis/processing unit so that the analysis/processing unit selects part of the acoustic signals from the database according to the command to produce a learning program and present the program on the learning interface.

11. The language learning system of claim 10, wherein the command comprises a voice command or a textual command.

12. The language learning system of claim 11, wherein the voice command is converted into a textual command after the voice recognition engine has recognized the voice command.

13. The language learning system of claim 9, wherein the database further holds full sentences, phrases and synonyms that are closely related to each first sentence.

14. The language learning system of claim 9, wherein the database further holds a plurality of second acoustic signals each corresponding to the pronunciation of a second sentence such that the pronunciation of each second sentence is similar to the pronunciation of the first sentence.

15. The language learning system of claim 9, wherein the first sentence is a single word, a phrase or a full sentence.
